(19) United States
(12) Patent Application Publication
(10) Pub. No.: US 2017/0351355 A1
(43) Pub. Date: Dec. 7, 2017

(54) INPUT DEVICE CONTROL FOR A DISPLAY PANEL

(71) Applicant: HEWLETT-PACKARD DEVELOPMENT COMPANY, L.P., HOUSTON, TX (US)

(72) Inventor: CHANG-CHENG HSIEH, TAIPEI CITY (TW)

(21) Appl. No.: 15/535,812

(22) PCT Filed: Feb. 26, 2015
(86) PCT No.: PCT/US15/17707

§ 371 Date: Jun. 14, 2017

(51) Int. Cl. G06F 3/044; G06F 3/0354; G06F 3/041; H04B 5/00

(52) U.S. Cl. CPC G06F 3/044; H04B 5/0031; G06F 3/03545; G06F 3/0412

(57) ABSTRACT

Some examples provide a method including sensing an input associated with a particular function among a capacitive touch panel function, a near field communication (NFC) function, and a digitizer panel function. The method may also include controlling an active input device for a display panel based on the input by activating the particular function and disabling the other two functions among the capacitive touch panel function, the NFC function, and the digitizer panel function that are not activated.

### BACKGROUND

With rapid advances in technology, electronic devices are used in virtually all facets of society today. Display technologies are also advancing, and interactive electronic displays are increasingly present inside homes, workplaces, and public spaces. Increases in the efficiency and capability of electronic devices and displays will result in further widespread use and adoption of technology in nearly every aspect of life.

### BRIEF DESCRIPTION OF THE DRAWINGS

Certain examples are described in the following detailed description and in reference to the drawings.

FIG. 1 shows an example of a device that supports input device control for a display panel.

FIG. 2 shows an example of control circuitry that supports input device control for a display panel.

FIG. 3 shows an example of logic that the control circuitry may implement.

FIG. 4 shows an example of device that supports input device control for a display panel.

### DETAILED DESCRIPTION

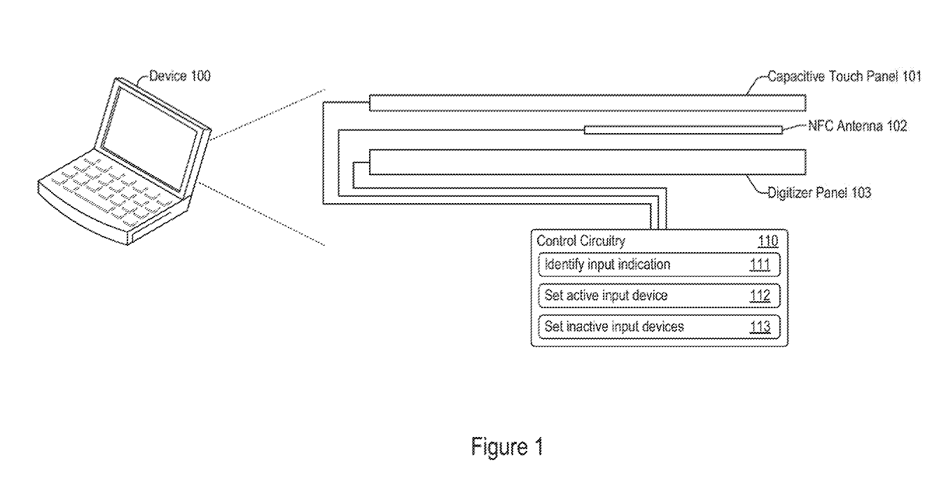

FIG. 1 shows an example of a device 100 that supports input device control for a display panel. The device 100 may be any electronic device that includes a display panel, which may also be referred to as a display screen. In the specific example shown in FIG. 1, the device 100 is a laptop computer. However, additional examples of the device 100 include a mobile device, smartphone, tablet device, desktop or all-in-one computer, personal digital assistant, wearable electronic device, television, computer monitor, any type of flat panel display, and more.

The device 100 may implement an interactive display panel through which a user may control the display. For example, the device 100 may provide various mechanisms to control the display of the device 100 such as directly touching the display or through another device such as stylus, pen, or mobile device. In that regard, the device 100 may include circuitry that supports the interactive display, including multiple types of input devices through which the device 100 receives inputs for controlling the display. In FIG. 1, the device 100 includes a capacitive touch panel 101, near field communication (NFC) antenna 102, and a digitizer panel 103, which are examples of input devices through which the device 100 may receive input data for controlling the device display. In some examples, the capacitive touch panel 101, NFC antenna 102, and digitizer panel 103 are implemented as part of a display panel itself.

The capacitive touch panel 101 may include circuitry that supports sensing a touch input. The capacitive touch panel 101 may thus include a touchscreen panel that senses when an electrical conductor (e.g., a human finger, specially coated glove, or stylus) touches the capacitive touch panel 101. The capacitive touch panel 101 may identify capacitance variations in the electrostatic field of the capacitive touch panel 101, such as when an electrical conductor touches the capacitive touch panel 101 itself. Accordingly, a user may control the display through touch inputs sensed through the capacitive touch panel 101.

The NFC antenna 102 of the device 100 may support display interaction and control through another electronic device separate from the device 100. The NFC antenna 102 or other NEC circuitry may receive input data through near field communications from a proximate electronic device. Thus, the NEC antenna 102 may support device-to-device communications to provide personalized displays, device control of the display panel, or more. Along similar lines, the NEC antenna 102 may support device-to-device transfer of data. While FIG. 1 provides one example of an NEC antenna 102, the device 100 may include any wireless communication circuitry to support display panel control through transmissions from a separate electronic device.

The digitizer panel 103 may sense when a particular electronic device is proximate to the display panel of the device 100. In that regard, the digitizer panel 103 may be an active digitizer that supports device interaction with a specific input device, e.g., an active digitizing pen or stylus. In some examples, the digitizer panel 103 recognizes inputs from a particular input source (e.g., active digitizer pen) but not others (e.g., electrical conductor input from a palm resting on the display panel). The digitizer panel 103 may support input and display interaction with increased accuracy and pin-point positioning through a particular electronic device recognized by an active, digitizer for example.

The capacitive touch panel 101, NEC antenna 102, and digitizer panel 103 are just some examples of input devices that the device 100 may implement to sense input data for controlling a display panel. Any number of other input devices may be implemented by the device 100 for controlling the display panel.

The control circuitry 110 may control any of the input devices through which the device 100 receives input data. In some examples, the control circuitry 110 sets an active input device from among multiple input devices through which the device 100 receives input data, e.g., to control a display. The control circuitry 110 may set the other remaining input devices as inactive input devices. In doing so, the control circuitry 110 may reduce interference that different input devices may cause when operating simultaneously. For example, electric and magnetic field variances caused from NFC or other wireless transmissions may reduce the effectiveness of the capacitive touch panel 101 and the digitizer panel 103. Noise radiating from the NFC antenna 102 or other circuitry may likewise impact the functioning of the capacitive touch panel 101 and digitizer panel 103. Interference from multiple active input devices may cause errant input detection, which may result in, for example, a screen cursor jumping locations errantly or other errant displays. Thus, the control circuitry 110 may reduce such interference, which may result in increased accuracy and control over the display panel.

As described in greater detail below, the control circuitry 110 may control functioning of the capacitive touch panel 101, NFC antenna 102, and digitizer panel 103, so as not to interfere with one another in controlling the display. In FIG. 1, the device 100 includes the modules 111, 112, and 113, which may implement particular features of the control circuitry 110 through any combination of circuitry, hardware, machine-readable instructions, and the like, The control circuitry 110 may identify an input indication to utilize a function associated with the capacitive touch panel 101, the NFC antenna 102, or the digitizer panel 103; set, as an active input device for a display panel, one of the capacitive touch panel 101, the NFC antenna 102, and the digitizer panel 103 according to the input indication; and set, as inactive input devices for the display panel, the other two among the capacitive touch panel 101, the NFC antenna 102, and the digitizer panel 103 which are not set as the active input device.

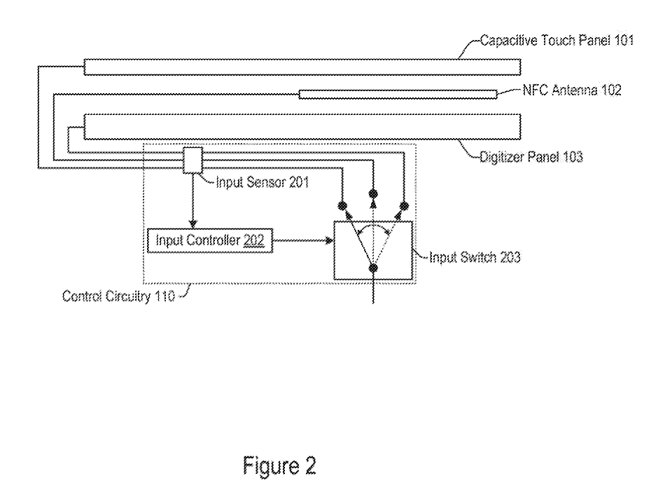

FIG. 2 shows an example of control circuitry 110 that supports input device control for a display panel. In the example shown in FIG. 2, the control circuitry 110 includes an input sensor 201, an input controller 202, and an input switch 203. The input sensors 201 may sense when an input has been received from an input device, such as the capacitive touch panel 101, the NFC antenna 102, or the digitizer panel 103. The input controller 202 may identify the sensed inputs and control the input switch 203 as to which of the input devices to set as active and which to set as inactive. In that regard, the input controller 202 may implement any of the control logic or features described with respect to the control circuitry 110 in determining which input device to set as active and which to set as inactive. In response to receiving an instruction from the input controller 202, the input switch 203 may toggle to the one of the capacitive touch panel 101, the NFC antenna 102, and the digitizer panel 103 to set an active input device for controlling a display panel.

The control circuitry 110 may set an active input device from among multiple input devices in a device 100 according to an input indication. The input indication may be, for example, a sensed input that the input sensor 201 identifies from the capacitive touch panel 101, the NFC antenna 102, or the digitizer panel 103, As another example, the, control circuitry 110 may obtain an input indication as a user input to use or disable a particular function. In this example, the control circuitry 110 may receive a user selection to specifically activate or deactivate an NFC function, a digitizer panel function, or a capacitive touch panel function, such as through a function selection user interface, a physical switch or button on the device 100 pressed by the user, or via any other user selection mechanisms.

Some examples of how the control circuitry 110 may determine to set an active input device (and inactive input devices) according to the input indication are presented next. In some examples, the control circuitry 110 sets the active input device as a particular input device from which input data was sensed. In these examples, the input sensor 201 may sense when input data is being received by the capacitive touch panel 101, the NEC antenna 102, or the digitizer panel 103, and the input controller 202 may set the input switch 203 according to whichever input device from which input data was sensed from. Accordingly, the control circuitry 110 may set, as the active input device, a particular input device from which input data is being received.

In some examples, the control circuitry 110 identifies a sensed input from a particular input device (e.g., the capacitive touch panel 101), and sets the particular input device as the active input device when no other input devices are receiving input data (e.g., when the NFC antenna 102 and the digitizer panel 103 are not presently receiving input data). When the input sensor 201 senses input data simultaneously from multiple input devices (e.g., at least two of the capacitive touch panel 101, NFC antenna 102, and the digitizer panel 103), the control circuitry 110 may account for any number of factors to determine a particular input device to set as the active input device.

In setting the active input device according to the input indication, the control circuitry 110 may prioritize a presently active input device. For example, the control circuitry 110 may maintain a presently active input device when inputs are sensed simultaneously from multiple input devices. The control circuitry 110 may identify a presently active input device when the currently configured active input device (e.g., as set by the input switch 203) is currently receiving input data or has received input data within a time threshold (e.g., input data received within the last 10 milliseconds or other configurable timing threshold). In one illustration, the control circuitry 110 may set the capacitive touch panel 101 as the active input device and determine the capacitive touch panel 101 as presently active when a touch input through the capacitive touch panel 101 is being presently received or has been received within the timing threshold (e.g., as sensed by the input sensor 201). Along similar lines, the control circuitry 110 may determine that the currently configured active input device is riot presently active, such when the capacitive touch panel 101 (e.g., set as the active input device by the input switch 203) has not received a touch input within a time period longer than the timing threshold.

Thus, when the control circuitry 110 identifies a sensed input from a particular input device when another input device is configured as the active input device and presently active, the control circuitry 110 may determine not to set the particular input device as the active input device. In this way, the control circuitry 110 may prioritize the presently active input device, e.g., by maintaining the currently configured active input device to receive input data for controlling the display panel instead of setting a different input device as the active input device. Put another way, when the active input device is presently active, the control circuitry 110 may determine not to set a different input device as the active input device even when input data is sensed for the different input device (and thus the different input device remains set as an inactive input device). In doing so, the control circuitry 110 may maintain continuity in input data received through the active input device, and a user may control a display panel through a particular input device without interruption.

Continuing the examples of setting an active input device (and inactive input devices) according to the input indication, the control circuitry 110 may prioritize particular input devices based on a preconfigured ordering. In that regard, the control circuitry 110 may maintain a priority listing of input devices in through which input data is received to control a display panel. The priority listing may be preconfigured or otherwise set by a user indication (e.g., via a function selection user interface or physical, switch). In some, implementations, the control circuitry 110 may set a particular input device as the active input device when the control circuitry 110 senses input data for the particular input device and the particular input device has a higher priority than the currently configured active input device.

In one illustration, the control circuitry 110 may maintain a priority listing ordered such that the capacitive touch panel 101 has a higher priority than the NFC antenna 102 and the digitizer panel 103. When the NFC antenna 102 or digitizer panel 103 is configured as the active input device (e.g., as set by the input switch 203) and the input sensor 201 senses input data received through the capacitive touch panel 101, the input controller 202 may instruct the input switch 203 to set the capacitive touch panel 101 as the active input device instead of the NFC antenna 102 or digitizer panel 103. Thus, sensed input data for a higher priority input device may cause the control circuitry 110 to preempt a lower priority input device as the active input device, which may ensure that input data received through the higher priority input device controls the display panel. Thus, the control circuitry 110 may set an active input device for controlling a display panel.

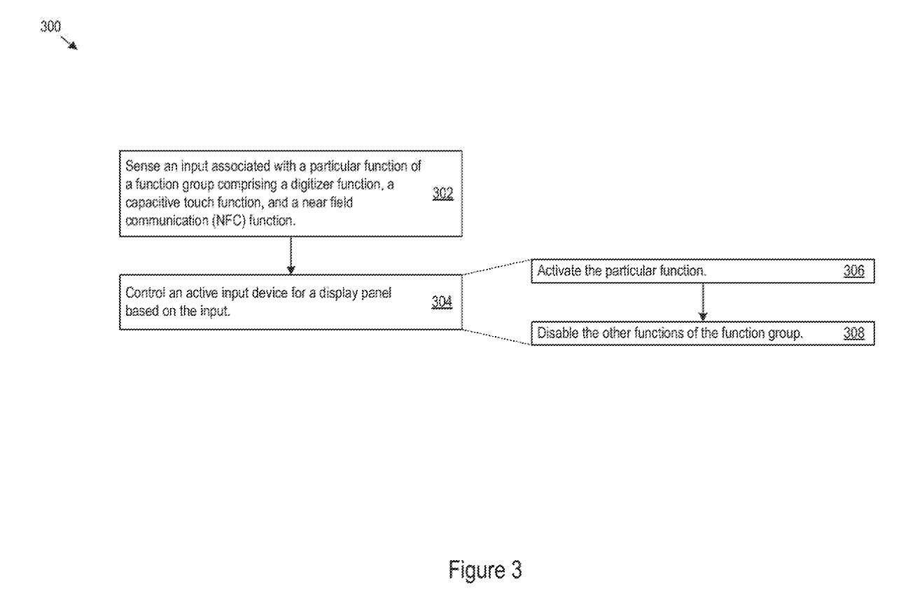

FIG. 3 shows an example of logic 300 that the control circuitry 110 may implement. The control circuitry 110 may implement the logic 300 as hardware or machine-readable instructions, for example. The control circuitry 110 may execute the logic 300 as a process or method to control the active input device for interacting with a display panel of a device 100.

The control circuitry 110 may sense an input associated with a particular function of a function group including a digitizer panel function, a capacitive touch panel function, and an NFC function (302). In response, the control circuitry 110 may control an active input device for the display panel based on the sensed input (304), e.g., according to any combination of the examples described above. In controlling the active input device, the control circuitry 110 may activate the particular function (306) and disable the other functions of the function group (308).

As one illustration, the control circuitry 110 may sense, as the input, a digitizer input associated with the digitizer panel function. The digitizer input may include sensing that an active digitizer pen is within a threshold proximity or touching a display panel surface, which the control circuitry 110 may identify through the digitizer panel 103. In that regard, the control circuitry 110 may sense the digitizer input as any input received through the digitizer panel 103. In response to sensing the digitizer input, the control circuitry 110 may control the active input device for the display panel by activating the digitizer panel function and disabling both the capacitive touch panel function and the NFC function.

As another illustration, the control circuitry 110 may sense, as the input, a touch input associated with the capacitive touch panel function. In doing so, the control circuitry 110 may sense the touch, input as any input received through the capacitive touch panel 101, e.g., when a finger or other electrical conductor touches the capacitive touch panel 101. In response, the control circuitry 110 may control the active input device for the display panel by activating the capacitive touch panel function and disabling both the digitizer function and the NFC function.

As yet another illustration, the control circuitry 110 may sense, as the input, an NFC signal associated with the NFC function. The sensed NFC signal may be an incoming NFC transmission from a proximate electronic device or an outgoing NFC transmission from the device 100 to the proximate electronic device. The control circuitry 110 may thus sense the NFC signal as communication activity performed through the NFC antenna 102. In response, the control circuitry 110 may control the active input device for the display panel by activating the NFC function and disabling both the digitizer panel function and the capacitive touch panel function.

The control circuitry 110 may activate a particular function and disable the other functions in various ways. For example, the control circuitry 110 may toggle the input switch 203 to set the input device providing the particular function as the active input device. In doing so, the input switch 203 may set the other non-activated devices as inactive input devices. As one example, the control circuitry 110 provides operating power or current for elements and circuitry implementing the particular function (e.g., the digitizer panel 103 for the digitizer panel function), but not to the elements and circuitry implementing the other functions (e.g., the capacitive touch panel 101 and NFC antenna 102 when the digitizer panel function is activated). As another example, the control circuitry 110 may activate the particular function by processing the input data received through the particular function. The control circuitry 110 may thus disable the other functions that are not activated by disregarding (e.g., not processing) input data received through the other functions. Accordingly, the input data received through the activated function may control the display panel (e.g., moving of a cursor, zooming in or out, selecting a particular icon, etc.), whereas input data received through disabled functions may provide no control of the display panel.

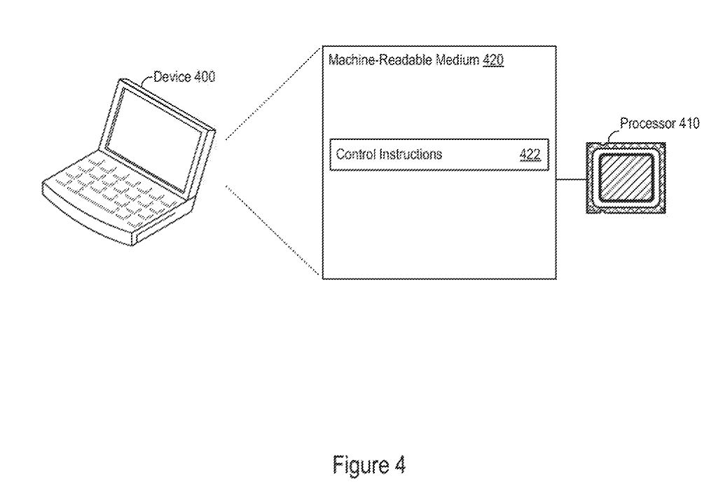

FIG. 4 shows an example of a device 400 that supports input device control for a display panel. In that regard, the device 400 may implement any of the functionality described herein, including any functionality described above for the control circuitry 110 or portion thereof.

The device 400 may include a processor 410. The processor 410 may include a central processing unit (CPU), microprocessor, and/or any hardware device suitable for executing instructions stored on a machine-readable medium. The device 400 may include a machine-readable medium 420, which may be non-transitory. The machine-readable medium 420 may be any electronic, magnetic, optical, or other physical storage device that stores executable instructions, such as the control instructions 422 shown in FIG. 4. Thus, the machine-readable medium 420 may be, for example, Random Access Memory (RAM), an Electrically-Erasable Programmable Read-Only Memory (EEPROM), a storage drive, an optical disk, and the like.

The device 400 may execute instructions stored on the machine-readable medium 420 through the processor 410. Executing the instructions may cause the device 400 to perform any of the features described herein. One specific example is shown in FIG. 4 through the control instructions 422. Executing the control instructions 422 may cause the device 400 to perform any combination of the features of the control circuitry 110 described above, for example implementing the features of the input controller 202. In some examples, executing the control instructions 422 causes the device 400 to identify an input from among a digitizer panel 103, a capacitive touch panel 101, and an NFC antenna 102; set, as an active input device for a display panel, one of the capacitive touch panel 101, the NFC antenna 102, and the digitizer panel 103 from which the input was identified; and set, as inactive input devices for the display panel, the other two among the capacitive touch panel 101, the NFC antenna 102, and the digitizer panel 103 not set as the active input device.

As described above, the control circuitry 110 may control an active input device through which input data is received for interacting with a display panel. In particular examples, the control circuitry 110 may set as an active input device a capacitive touch panel 101 to support a capacitive touch panel function, an NFC antenna 102 to support an NFC function, or a digitizer panel 103 to support a digitizer panel function, while setting other input devices as inactive. Accordingly, the control circuitry 110 may reduce interference caused when these multiple input devices operate simultaneously, allowing for a more accurate display and smoother user excellence.

The methods, devices, systems, and logic described above, including the control circuitry 110 or any portion thereof, may be implemented in many different ways in many different combinations of hardware, software (e.g., in the form of machine readable instructions) or both hardware and software. For example, the control circuitry 110 may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and computer readable instructions stored on the medium, which when executed in an endpoint, computer system, or other device, cause the device to perform operations according to any of the description above.

The processing capability of the systems, devices, and circuitry described herein, including the control circuitry 110 or any portion thereof, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various examples have been described above, many more implementations are possible.

1. A method comprising:
through control circuitry of a device:
sensing an input associated with a particular function among a capacitive touch panel function, a near field communication (NFC) function and a digitizer panel function;
controlling an active input device for a display panel based on the input by:
activating the particular function; and
disabling the other two functions among the capacitive touch panel function, the NFC function, and the digitizer panel function that are not activated.

2. The method of claim 1, wherein sensing the input comprises sensing a digitizer input associated with the digitizer panel function; and
wherein controlling the active input device comprises:
activating the particular function by activating the digitizer panel function; and
disabling the other two functions by disabling both the capacitive touch panel function and the NFC function.

3. The method of claim 1, wherein sensing the input comprises sensing a touch input associated with the capacitive touch panel function; and
wherein controlling the active input device comprises:
activating the particular function by activating the capacitive touch panel function; and
disabling the other two functions by disabling both the digitizer panel function and the NFC function.

4. The method of claim 1, wherein sensing the input comprises sensing an NFC signal associated with the NFC function; and
wherein controlling the active input device comprises:
activating the particular in ion by activating the NFC function; and
disabling the other two functions by disabling both the digitizer panel function and the capacitive touch panel function.

5. The method of claim 1, wherein, activating the particular function and disabling the other two functions comprises operating a switch to provide power for the particular function but not for the other two functions.

6. The method of claim 1, wherein activating the particular function and disabling the other two functions comprises processing input data received through the particular function and disregarding input data received through the other functions.

7. A device comprising:
a capacitive touch panel;
a near field communication (NFC) antenna;
a digitizer panel; and
control circuitry to:
identify an input indication to utilize a function associated with the capacitive touch panel, the NFC antenna, or the digitizer panel;
set, as an active input device for a display panel, one of the capacitive touch panel, the NFC antenna, and the digitizer panel according to the input indication; and
set, as inactive input devices for the display panel, the other two among the capacitive touch panel, the NFC antenna, and the digitizer panel not set as the active input device.

8. The device of claim 7, wherein the control circuit is to identify the input indication as a user input requesting use of the function.

9. The device of claim 7, wherein the control circuitry comprises an input sensor to identify the input indication by sensing an input from the capacitive touch panel, the NFC antenna, or the digitizer panel.

10. The device of claim 7, wherein the control circuitry comprises an input controller to determine which of the capacitive touch panel, the NFC antenna, or the digitizer panel to set as the active input device according to the input indication.

11. The device of claim 7, wherein the control circuitry comprises an input switch to set the active and inactive input devices by toggling to one of the capacitive touch panel, the NFC antenna, or the digitizer panel as the active input device.

12. A product comprising:
a non-transitory machine readable medium storing thereon executable instructions, which, when executed, cause a device to:
identify an input from among a capacitive touch panel, a near field communication (NFC) antenna, and a digitizer panel;
set, as an active input device for a display panel, one of the capacitive touch panel, the NFC antenna, and the digitizer panel from which the input was identified; and
set, as inactive input devices for the display panel, the other two among the capacitive touch panel, the NFC antenna, and the digitizer panel not set as the active input device.

13. The product of claim 12, wherein the executable instructions cause the device to set the active input device and the inactive input devices by sending a control command to an input switch to toggle to the one of the capacitive touch panel, the NFC antenna, and the digitizer panel from which the input was identified.

14. The device of claim 12, wherein the executable instructions further cause the device to identify inputs simultaneously from two of the capacitive touch panel, the NFC antenna, and the digitizer panel; and
set the active input device from between the two of the capacitive touch panel, the NFC antenna, and the digitizer panel according to a priority listing.

15. The device of claim 12, wherein the executable instructions further cause the device to identify inputs simultaneously from two of the capacitive touch panel, the NFC antenna, and the digitizer panel; and
set the active input device from between the two of the capacitive touch panel, the NFC antenna, and the digitizer panel to maintain a current active input device.
